(19) United States
(12) Patent Application Publication
(10) Pub. No.: US 2011/0049060 A1
(43) Pub. Date: Mar. 3, 2011

(54) INDICATORS PRINCIPALLY FOR USE IN CONNECTION WITH WATER-TREATMENT MATERIALS FOR POOLS AND SPAS

(76) Inventor: DINDO UY, North Hollywood, CA (US)

(21) Appl. No.: 12/861,850

(22) Filed: Aug. 24, 2010

Related U.S. Application Data
(60) Provisional application No. 61/275,036, filed on Aug. 25, 2009.

(51) Int. Cl. E04H 4/14; C02F 1/00; G08B 21/00

(52) U.S. Cl. 210/749; 210/85; 340/540

(57) ABSTRACT

Indicators especially (although not necessarily exclusively) useful for assessing effectiveness of pool or spa water-treatment materials are described. The indicators may provide effectiveness information visually or otherwise, with certain versions including a numerical or graphical display with or without a warning light. Various versions additionally may connect directly to housings containing the water-treatment materials and be removable therefrom as desired.

REFERENCE TO PROVISIONAL APPLICATION

This application is based on, claims priority to, and hereby refers to U.S. Provisional Patent Application Ser. No. 61/275,036, filed Aug. 25, 2009, the entire contents of which are incorporated herein by this reference.

### FIELD OF THE INVENTION

This invention relates to indicators and more particularly, although not necessarily exclusively, to devices adapted to provide information relevant to determining whether water-treatment materials for pools and spas should be replaced.

### BACKGROUND OF THE INVENTION

Recreational and therapeutic vessels such as pools and spas typically contain water susceptible to growth of bacteria or other microorganisms potentially harmful to human health. As a consequence of this susceptibility, pool and spa owners are counseled to treat the water with chemicals intended to kill certain microorganisms or render them less harmful to humans. Adding chlorine directly to pool and spa water, for example, has long been an accepted method of treating the water.

More recently, flow-through canisters or cartridges have been developed for use in pools and spas. Some of these cartridges may be placed in housings plumbed in-line as part of the water-circulation systems of the pools and spas. When no longer effective, the cartridges may be removed from the housings and replaced.

Commercially marketed by the assignee of the application under the “Nature2” name are silver-containing materials useful in addition to, or as replacement for part of, the chlorine conventionally added to the water. The silver-containing materials may be placed within flow-through cartridges, which in turn are positioned within housings plumbed into (or otherwise connected to) the water-circulation systems. Accordingly, circulating pool or spa water may enter a housing, flow through its associated cartridge in contact with the silver-containing material, and exit the housing for eventual return to the pool or spa. U.S. Pat. No. 5,855,777 to Bachand, et al., describes various of many examples of these cartridges and housings.

Irrespective of the type of chemicals used to treat the water, the chemicals within (or created by) the cartridge eventually dissolve, erode, or otherwise are removed from the cartridge. At some time the cartridge becomes insufficiently effective to accomplish its intended purpose and thus should be replaced. Frequently, though, the cartridge is not immediately visible to the pool or spa owner (because positioned within a housing, for example) or, even if visible, is not immediately recognizable as requiring replacement. Further, because “Nature2”-type cartridges of the assignee may be useful for extended periods (on the order of six months), consumers have time to forget about the existence of the cartridges and their need for eventual replacement. Need thus exists to indicate to pool and spa owners, or their employees or agents, when water-treatment materials should be replaced.

### SUMMARY OF THE INVENTION

The present invention provides indicators useful for this purpose. The indicators may provide information visually, aurally, tactilely, or otherwise as desired. Preferably, however, the indicators provide at least some information visually, with certain versions including both a graphical or numerical display and a warning light. Other embodiments of the invention provide a weekly countdown starting, for example, at twenty-six weeks; when the countdown is complete, the warning light illuminates and begins to blink. Persons skilled in the art will, of course, recognize that any numerical display may provide information other than or in addition to a weekly countdown and any warning light (if present) may activate prior to or after the countdown is complete or, when activated, illuminate continuously rather than in a flashing manner.

Likewise, any visual display need not necessarily be numerical. As one example, such a non-numerical visual display may comprise a multi-element bar graph, with bars either appearing or disappearing as a function of time. A six-element bar graph may be especially useful for indicating remaining useful life of a six-month product such as the cartridge mentioned above, as each bar may represent one month of product life. As another example, a graphical display may include a representation of a pointer and multiple areas signifying remaining useful life, with the pointer pointing to different areas as a function of elapsed time.

Versions of the invention may connect directly to the cartridge-containing housings. This connection is useful both to avoid loss or misplacement of an indicator and to identify to persons maintaining pools or spas that cartridge placement may then or soon be required. However, these versions additionally may be disconnected from the housings and moved to alternate locations if desired. Indeed, some persons having outdoor pools may prefer to move the indicators indoors so as to be able to ascertain effectiveness information without needing to venture outside. Whether the indicators are indoors or outdoors, though, optional mounting plates or other structures may permit attachment of the indicators to numerous other objects via magnets, tape, hooks, or other devices.

It thus is an optional, non-exclusive object of the present invention to provide indicators configured to provide information visually, aurally, tactilely, or otherwise as desired.

It is another optional, non-exclusive object of the present invention to provide indicators useful in identifying when materials used to treat pool or spa water should be replaced.

It is also an optional, non-exclusive object of the present invention to provide indicators having either numerical displays adapted to provide countdowns of the effectiveness of materials or graphical displays (or both).

It is, moreover, an optional, non-exclusive object of the present invention to provide indicators having warning lights.

It is a further optional, non-exclusive object of the present invention to provide indicators configured for connection to housings containing water-treatment cartridges.

It is yet another optional, non-exclusive object of the present invention to provide indicators which may be disconnected from the housings and either used as freestanding objects or mounted to other objects (either indoors or outdoors).

Other objects, features, and advantages of the invention will be apparent to those skilled in the relevant art with reference to the remaining text and drawings of this application.

### BRIEF DESCRIPTION OF THE DRAWINGS

FIG. 1 is a plan view of an exemplary indicator of the present invention.

FIGS. 2A-B are perspective views of the indicator of FIG. 1 with an optional mounting plate attached.

FIGS. 3A-B are exploded perspective views of the indicator and mounting plate of FIGS. 2A-B.

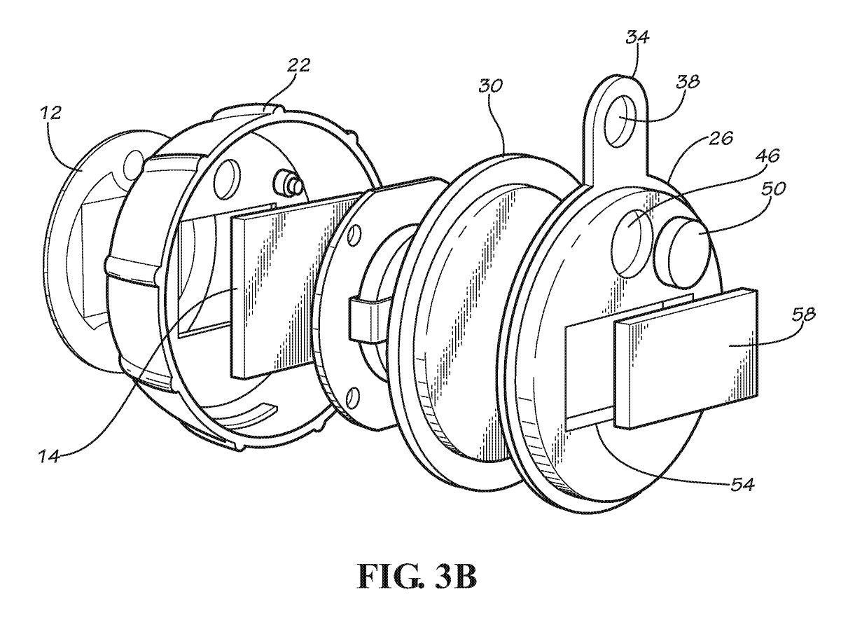

FIGS. 4A-C are various views of the indicator of FIG. 1 as attached to a housing.

FIG. 5 is a cross-sectional view of the indicator of FIG. 1.

FIG. 6 is a cross-sectional view of the indicator and mounting plate of FIG. 2.

FIG. 7 is a plan view of a display or an alternate exemplary indicator of the present invention.

FIG. 8 is an exploded perspective view of an alternate exemplary indicator of the present invention.

### DETAILED DESCRIPTION

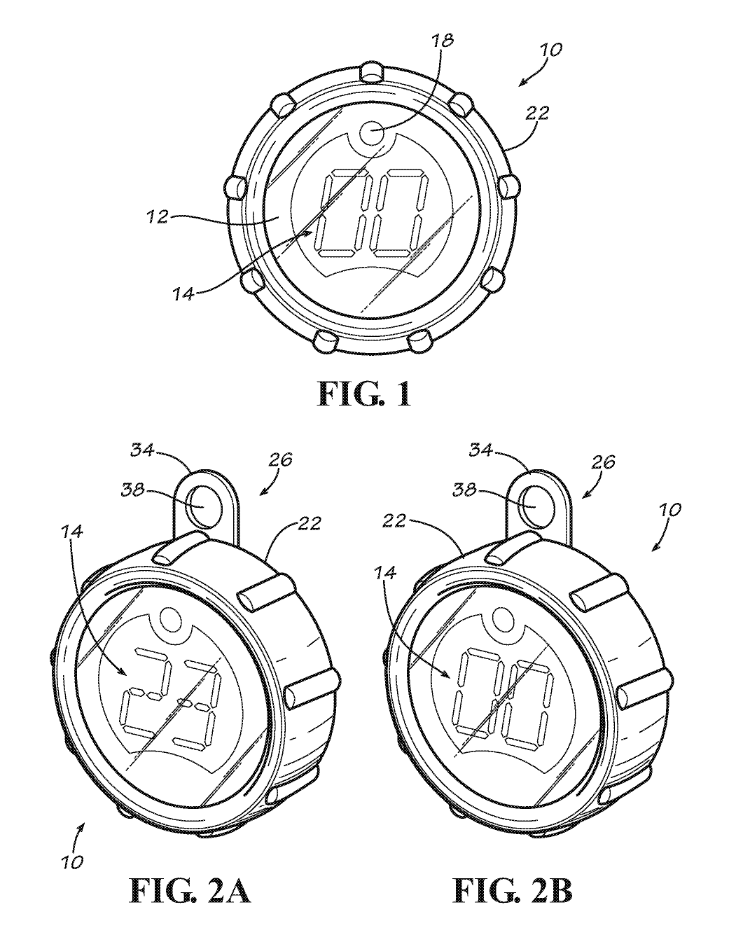

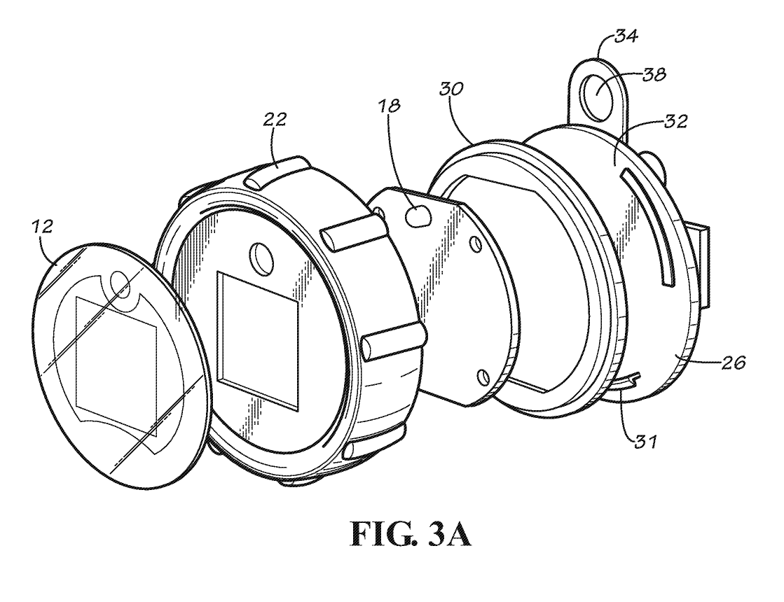

Illustrated in FIG. 1 is exemplary indicator 10 of the present invention. Indicator 10 may include a front, or face 12 through which numerical (or other) display 14 and optional warning light 18 are visible. Indicator 10 additionally may include body 22 of any appropriate shape and size. In at least one version of the invention, indicator 10 is designed to provide a weekly countdown from approximately twenty-six to zero, with light 18 illuminating discontinuously (i.e. blinking) when the countdown reaches zero. FIG. 2A depicts indicator 10 part-way through the countdown (at twenty-three weeks as shown on display 14), whereas FIGS. 1 and 2B illustrate a completed countdown (with “00” appearing on display 14). Indicator 10 may, however, be configured differently than as shown in FIGS. 1 and 2A-B and may provide information other than a weekly countdown or via a warning light. Nevertheless, for at least certain of the assignee's “Nature2” products, configuring indicator 10 to count down weekly from “26” to “00” is beneficial, as the assignee typically recommends replacing the cartridges containing the products every approximately twenty-six weeks.

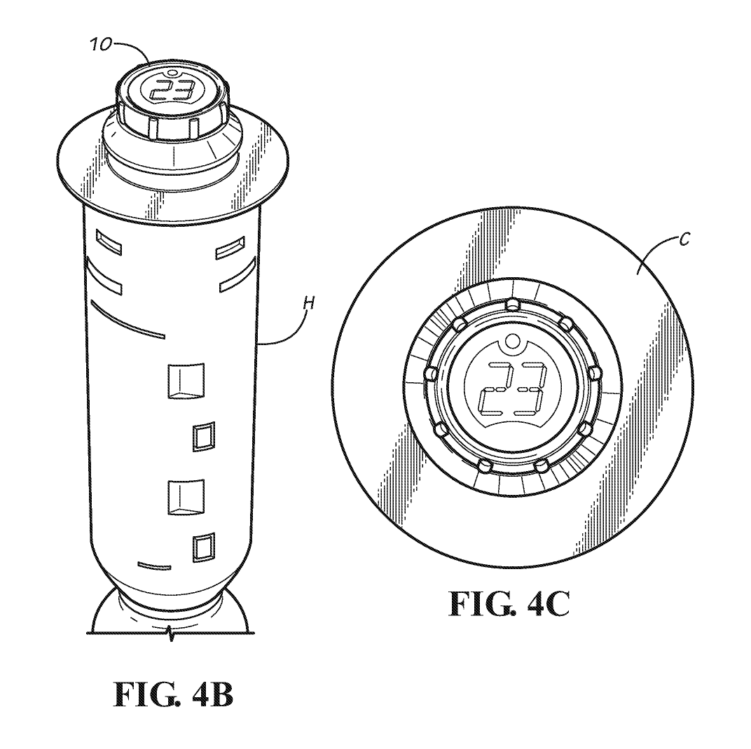

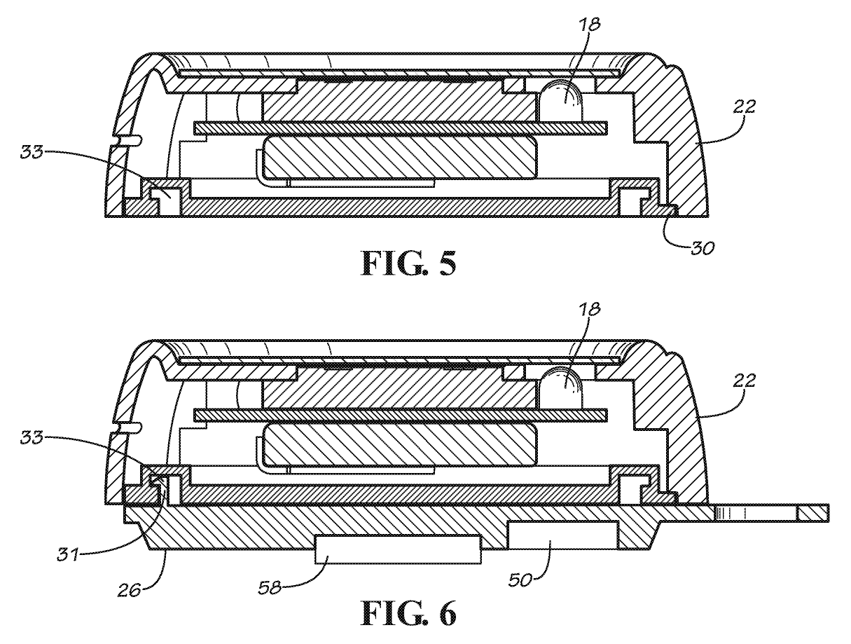

Shown in FIGS. 2A-B and 3A-B is optional mounting plate 26. Mounting plate 26 may attach to rear section 30 of body 22 in any appropriate way. Alternatively, mounting plate 26 may be formed integrally with body 22. As detailed in FIGS. 5-6, one or more flanged tabs 31 may extend from internal face 32 of plate 26 into suitable recesses 33 of rear section 30.

Mounting plate 26 may comprise hook 34 including opening 38. Opening 38 may receive a protruding object, such as a nail or peg, to connect indicator 10 to another structure (e.g. an interior wall of a house). External face 42 of plate 26 additionally may, if desired, include first recess 46 into which magnet 50 may be fitted and second recess 54 into which double-sided tape 58 may be inserted. Either or both of magnet 50 and tape 58 may function to connect indicator 10 to another structure (either in addition to or in lieu of hook 34).

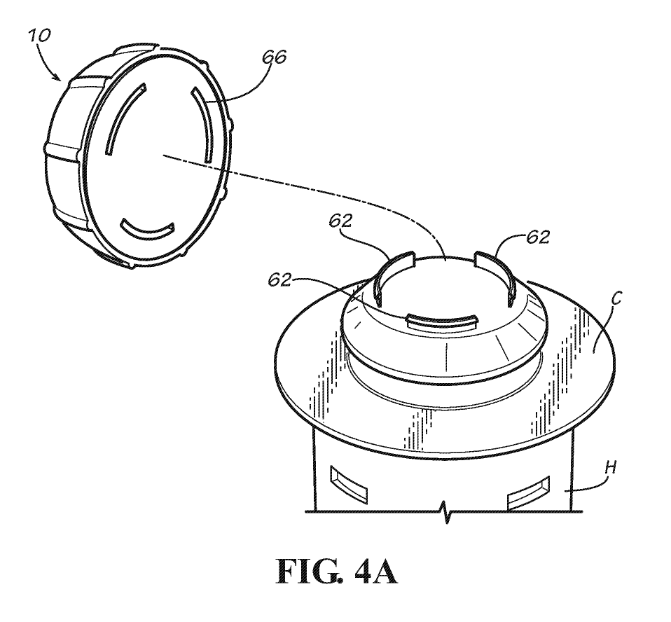

FIGS. 4A-C depict portions of an exemplary housing H with which indicator 10 may be used. Housing H preferably contains a removable cartridge which in turn contains water-treatment material such as (but not limited to) a mineral sanitizer, chlorine, or bromine. Because effectiveness of the water-treatment material diminishes as a function of time, eventually the cartridge will need to be removed for replacement.

By appropriately configuring mating surfaces of indicator 10 and housing H, the indicator 10 may be attached to the housing H. FIGS. 4A-C show indicator 10 connected to cover C of housing H, with one or more flanges 62 snap-fitting into channel 66 of rear section 30. Other attachment means may be used instead, however. If cover C is removable, when the countdown of display 14 reaches zero and warning light 18 activates, someone may simply remove cover C, remove and replace the cartridge within housing H, replace cover C, and attach a new indicator 10 to the cover C. These steps need not proceed in the recited order, though, and removal of the cartridge may occur either before or after the countdown reaches zero. Alternatively, if cover C is permanently attached to housing H and the cartridge need be replaced, indicator 10 may be disconnected from cover C before the combination of cover C, housing H, and the cartridge is discarded, thus allowing reuse of indicator 10 even when cover C and housing H are disposable.

Indicator 10 may be activated in any suitable manner. Presently envisioned is a pushbutton switch which, when depressed for a period of time, will activate the indicator 10. Also envisioned in some embodiments is that, once activated, indicator 10 cannot be reset. In alternate embodiments, though, indicator 10 may include a reset mechanism—which may or may not be hidden from the user. In at least some of these alternate embodiments, the same pushbutton switch may, when depressed for a longer period of time, effect resetting of the indicator 10. In yet other alternate embodiments, an insulating film or sheet may be placed between a terminal of a battery of indicator 10 and its corresponding electrical contact. To activate the indicator 10, a user may simply remove the insulating sheet, thereby allowing physical contact between the battery terminal and electrical contact so as to complete an electrical circuit.

As is apparent from the foregoing description, indicator 10 resolves the long-standing problem in the industry of identifying to consumers when pool and spa water-treatment cartridges need replacement. It does so, furthermore, in a simple, inexpensive way. Although conceivably the indicator could be coupled to more complex electronic circuitry, computational devices, or wired or wireless transmitters or transceivers, preferred versions maintain the simplicity of indicator 10. Because low-cost, an indicator 10 may be included with each housing H sold to consumers and with each replacement cartridge; indicator 10 also may be sold as a standalone item. Similarly, consumers need not hesitate for cost considerations before discarding an indicator 10 when its associated cartridge is discarded.

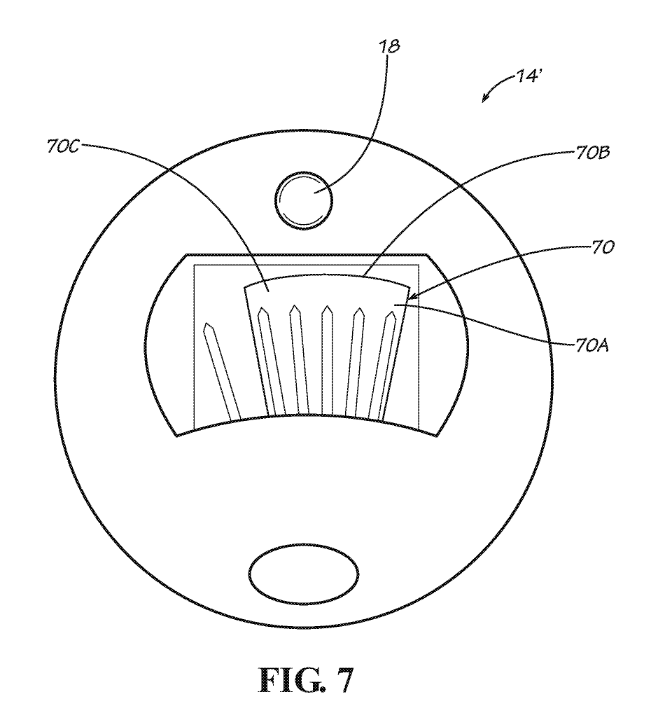

Depicted in FIG. 7 is an alternate display 14′, preferably a liquid crystal display (LCD), as well as pushbutton switch 180. Rather than providing a countdown or other numerical information, display 14′ may provide representations of a pointer 68 and one or more regions 70, which may be colored differently. Three such regions are shown in FIG. 7: first region 70A (which may be colored green); second region 70B (which may be colored yellow); and third region 70C (which may be colored red). Adjacent region 70C the word “REPLACE” optionally appears.

Upon activation of the indicator 10 by depressing switch 180, pointer 68 is shown at or adjacent first region 70A. Thereafter, as time elapses, pointer 68 is depicted in second region 70B and then in third region 70C (including any intermediate depictions), alerting a consumer to the limited useful life of the indicator 10. Displacement of pointer 68 preferably is constant as a function of time (at least until the pointer 68 indicates “REPLACE”), although variable movement of pointer 68 may occur instead.

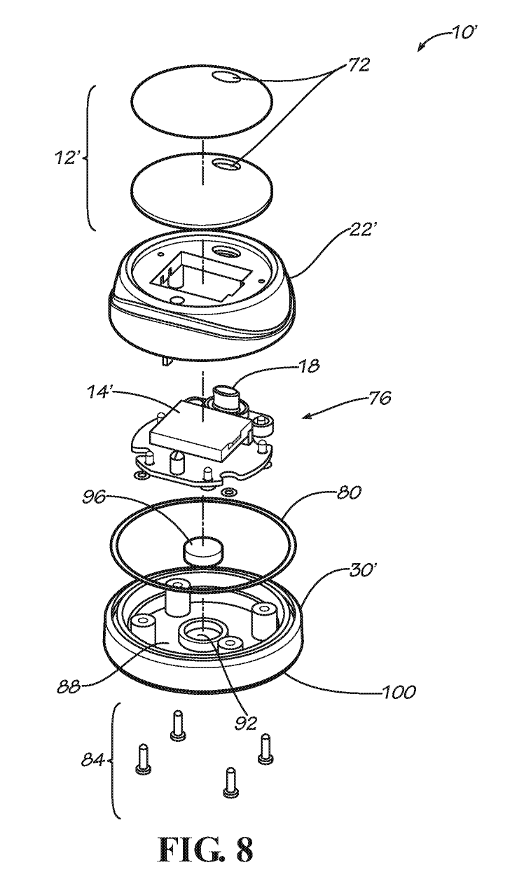

FIG. 8, finally, illustrates alternate indicator 10′ of the present invention. Indicator 10′ may include a display, such as (LCD) display 14′ (with or without a warning light), visible through an appropriate window or opening (not shown) of face 12′. Face 12′ may comprise another opening 72 through which pushbutton switch 180 may protrude. In use, display 14′ and timer assembly 76 may be fitted between body 22′ and rear section 30′. Optional ring 80, if present, likewise may be fitted between body 22′ and rear section 30′ for sealing or orientation purposes (or both). Screws 84 or any other appropriate fasteners may connect various components of indicator 10′.

Interior surface 88 of rear section 30′ may comprise recess 92. Such recess 92 may be designed to receive magnet 96; hence, when indicator 10′ is assembled, magnet 96 will be secured therein. Using magnet 96, indicator 10′ may be attached to metal surfaces. Alternatively or additionally, double-sided tape or other adhesive may connect exterior surface 100 of rear section 30′ to other (non-metallic or metallic) surfaces.

The foregoing is provided for purposes of illustrating, explaining, and describing embodiments of the present invention. Modifications and adaptations to these embodiments will be apparent to those skilled in the art and may be made without departing from the scope or spirit of the invention. Additionally, the contents of the Bachand patent are incorporated herein in their entirety by this reference.

What is claimed is:

1. A water-treatment effectiveness indicator comprising:
a. a time-varying visual display; and
b. means for connecting the display to an object.

2. An indicator according to claim 1 further comprising means for a user to activate the display.

3. An indicator according to claim 2 in which the display is configured to provide numerical or graphical information relating to effectiveness of a water treatment system.

4. An indicator according to claim 3 further comprising a warning light.

5. An indicator according to claim 3 further comprising a body having a rear section.

6. An indicator according to claim 5 in which the connecting means comprises a magnet.

7. An indicator according to claim 6 in which the rear section has an interior surface comprising a recess into which the magnet is fitted.

8. An indicator according to claim 5 in which the rear section has an exterior surface and the connecting means comprises double-sided tape attached to the exterior surface.

9. A water-treatment system comprising:
a. a housing comprising a cover;
b. a disposable cartridge, containing at least one depletable chemical, positionable in the housing; and
c. an indicator of effectiveness of the disposable cartridge comprising:
i. a time-varying visual display; and
ii. means for connecting the display to the cover.

10. A method of treating water as part of a pool- or spa-water recirculation system, comprising:
a. providing a housing having a cover and in which a cartridge containing a depletable chemical is placed;
b. causing water to flow into an inlet of a housing into contact with the depletable chemical and then through an outlet of the housing;
c. displaying, in a time-varying manner, information relating to the effectiveness of the cartridge; and
d. replacing at least the cartridge as a result of the displayed information.
